(19) United States
(12) Patent Application Publication
(10) Pub. No.: US 2019/0155950 A1
(43) Pub. Date: May 23, 2019

(54) EVENT REMINDING METHOD, DEVICE AND SERVER

(71) Applicant: Beijing Baidu Netcom Science and Technology Co., Ltd., Beijing (CN)

(72) Inventors: Zhongxue Niu, Beijing (CN); Xiaobo Liu, Beijing (CN); Min Qiao, Beijing (CN); Jun Zhou, Beijing (CN); Renkai Yang, Beijing (CN)

(21) Appl. No.: 16/128,445

(22) Filed: Sep. 11, 2018

(30) Foreign Application Priority Data
Nov. 22, 2017 (CN) 201711172725.9

(51) Int. Cl. G06F 17/30; G06F 9/54

(52) U.S. Cl. CPC G06F 17/30864; G06F 9/542

(57) ABSTRACT

An event reminding method and device as well as a mobile terminal are provided. The event reminding method includes: providing a user with information about a preset event for which the user requests a search; receiving a reminder request for the preset event from the user, the reminder request including a reminder triggering condition; and setting a reminder for the preset event; detecting whether the reminder triggering condition is met; and sending a reminder for the preset event to the user when the reminder triggering condition is met.

### CROSS-REFERENCE TO RELATED APPLICATION

This application claims priority to Chinese Patent Application No. 201711172725.9, filed on Nov. 22, 2017, which is hereby incorporated by reference in its entirety.

### TECHNICAL FIELD

The disclosure relates to the field of communication technology, and in particular to an event reminding method, device and server.

### BACKGROUND

Currently, a lot of information is not networked. Therefore, the information that can be currently retrieved by search engines occupies only a very small part of all the information that exists. More information exists in the Hidden Web. With the development of web search technology, some open search platforms, such as the Aladdin platform, can open the interface to the owners of unique information data, thereby solving the problem that Hidden Web information cannot be captured and retrieved by existing search engines. For example, the information concerning a date such as a movie release date or a national day of commemoration that a user intends to search can also be searched through this kind of open search platform.

However, this kind of open search platform only provides users with question-and-answer services, which means that the users enter search words and then the open search platform provides search results to the users. Therefore, the service content is relatively singular.

### SUMMARY

Embodiments of the disclosure provide an event reminding method, device and server with the purpose of at least solving the one or more technical problems in the background art.

In a first aspect, an event reminding method is provided according to an embodiment of the disclosure, the method includes:

providing a user with information about a preset event for which the user requests a search;

receiving a reminder request for the preset event from the user, the reminder request including a reminder triggering condition; and setting a reminder for the preset event;

detecting whether the reminder triggering condition is met; and

sending a reminder for the preset event to the user when the reminder triggering condition is met.

In conjunction with the first aspect, in a first embodiment of the first aspect of the disclosure, before providing a user with information about a preset event for which the user requests a search, the method further includes:

receiving a search request for a preset event from the user, the search request including a search keyword of the preset event;

searching for webpage information containing the search keyword according to the search request, to obtain information about the preset event.

In conjunction with the first aspect, in a second embodiment of the first aspect of the disclosure, the method further includes: receiving a request for managing the reminder from the user, wherein said managing includes at least one of the following operations: addition, deletion and modification.

In conjunction with the first aspect, in a third embodiment of the first aspect of the disclosure, the reminder information includes reminding content, reminding time and reminding manner.

In conjunction with the third embodiment of the first aspect, the reminding manner includes at least one of: short message, email, and phone call.

In a second aspect, an event reminding method is provided according to an embodiment of the disclosure, the method includes:

receiving information about a preset event from a web search platform;

sending a reminder request for the preset event to the web search platform, the reminder request including a reminder triggering condition; and

receiving a reminder for the preset event sent by the web search platform when the reminder triggering condition is met.

In a third aspect, an event reminding device is provided according to an embodiment of the disclosure, the device includes:

a providing module configured for providing a user with information about a preset event for which the user requests a search;

a first receiving module configured for receiving a reminder request for the preset event from the user, the reminder request including a reminder triggering condition; and setting a reminder for the preset event;

a detecting module configured for detecting whether the reminder triggering condition is met; and

a sending module configured for sending a reminder for the preset event to the user when the reminder triggering condition is met.

In conjunction with the third aspect, a first embodiment is provided according to the disclosure, in which the device further includes:

a second receiving module configured for receiving a search request for a preset event from a user, the search request including a search keyword of the preset event; and

a searching module configured for searching for webpage information containing the search keyword according to the search request, to obtain information about the preset event.

In conjunction with the third aspect, a second embodiment is provided according to the disclosure, in which the device further includes:

a third receiving module configured for receiving a request for managing the reminder from the user; wherein said managing includes at least one of the following operations: addition, deletion and modification.

In a fourth aspect, a server is provided according to an embodiment of the disclosure, the server includes:

one or more processors;

a storage device, configured for storing one or more programs; and

a communication interface, configured for enabling the processor and the storage device to communicate with an external device;

wherein the one or more programs are executed by the one or more processors, to enable the one or more processors to implement the methods described above.

In a fifth aspect, a computer-readable storage medium is provided according to an embodiment of the disclosure, in which a computer program is stored, wherein the computer program implements the methods described above when executed by a processor.

One of the above-described technical solutions has the following advantages or advantageous effects: a user, when using a web search platform, can directly send a reminder request for a preset event whose related information is displayed on the web search platform, and when a reminder triggering condition is met, the web search platform sends reminder information for the preset event to the user; the web search platform can provide more diversified services for the user and offer convenience for the user in a better way.

The above summary is provided only for illustration, and is not intended to limit the disclosure in any way. In addition to the illustrative aspects, embodiments and features described above, further aspects, embodiments and features of the present disclosure may be readily understood from the following detailed description with reference to the drawings.

### BRIEF DESCRIPTION OF THE DRAWINGS

Unless otherwise specified, identical or similar parts or elements are denoted by identical reference signs throughout several figures of the drawings. The drawings are not necessarily drawn to scale. It should be understood that these drawings merely illustrate some embodiments of the present disclosure, and should not be construed as limiting the scope of the disclosure.

FIG. 1 is a flowchart of an event reminding method according to Embodiment 1 of the present disclosure;

FIG. 2 is a schematic diagram of one of the application scenarios of the event reminding method according to Embodiment 1 of the present disclosure;

FIG. 3 is a flowchart of an event reminding method according to Embodiment 2 of the present disclosure;

FIG. 4 is a schematic diagram of one of the application scenarios of the event reminding method according to Embodiment 2 of the present disclosure;

FIG. 5 is a flowchart of an event reminding method according to Embodiment 3 of the present disclosure;

FIG. 6 is a schematic diagram of an event reminding device according to Embodiment 4 of the present disclosure; and

FIG. 7 is a schematic diagram of a server according to embodiment 5 of the present disclosure.

### DETAILED DESCRIPTION

Hereinafter, only some exemplary embodiments are simply described. As can be recognized by those skilled in the art, the described embodiments may be modified in various ways without departing from the spirit or scope of the present disclosure. Accordingly, the drawings and the description should be considered as illustrative in nature instead of being restrictive.

In a traditional event reminding method, a user learns that an event is about to occur through a network or other channels in advance, and then the user sets a reminder on his/her own terminal device such as a mobile phone, a computer, etc., for example, setting the reminder in the calendar or in the memo. When an event occurs, or within a period of time before an event occurs, the terminal device sends a reminder to the user so that the user can avoid missing the event. However, the process of this event reminding method is complicated, and errors are easy to occur when the user manually sets the reminder. The present disclosure provides the user with an event reminding method, device and server for reducing steps of setting a reminder.

### Embodiment 1

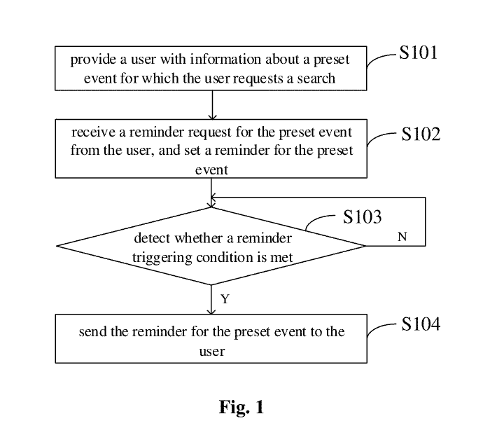

An event reminding method is provided according to Embodiment 1 of the present disclosure. As shown in FIG. 1, the event reminding method according to Embodiment 1 of the present disclosure includes steps S101-S103.

S101, the user is provided with information about a preset event for which the user requests a search.

S102, a reminder request for the preset event is received from the user, the reminder request including a reminder triggering condition; and a reminder for the preset event is set.

An application scenario of this embodiment is that a preset event can be found by searching when the user uses a web search platform for searching. For example, if a movie is about to be released and the user is very interested in the movie, it may be desirable to set a reminder for the release date of the movie in order to avoid missing the movie. Accordingly, the user can send a reminder request for the release on the web search platform, whereby the web search platform sends reminder information to the user before the release date of the movie or on the release date of the movie.

In addition, when the user sends the reminder request, a reminder triggering condition is included in the reminder request. For example, if the time is taken as the triggering condition, the user may request a server of the web search platform to send reminder information to the user 29 hours before the preset event occurs.

S103, detecting whether the reminder triggering condition is met; if yes, step S104 is executed; otherwise, the detection continues.

Specifically, the triggering condition may be time, geographic location or the like. For example, if the user sends a reminder request for the release date of a movie, a reminder would be triggered when a preset time before the release date of the movie is reached, and the web search platform will send the reminder information to the user. Further, if the reminder request includes a reminder of geographic location, for example, if the user intends to see the Chinese movie “Life After Life, Blooms Over Blooms” at a designated movie theater on *(month) *(day), the reminder could be sent to the user when he/she approaches the movie theater. Of course, this method also requires the user to locate himself/herself with a terminal device and send the location to the web search platform.

S104, a reminder for the preset event is sent to the user when the reminder triggering condition is met.

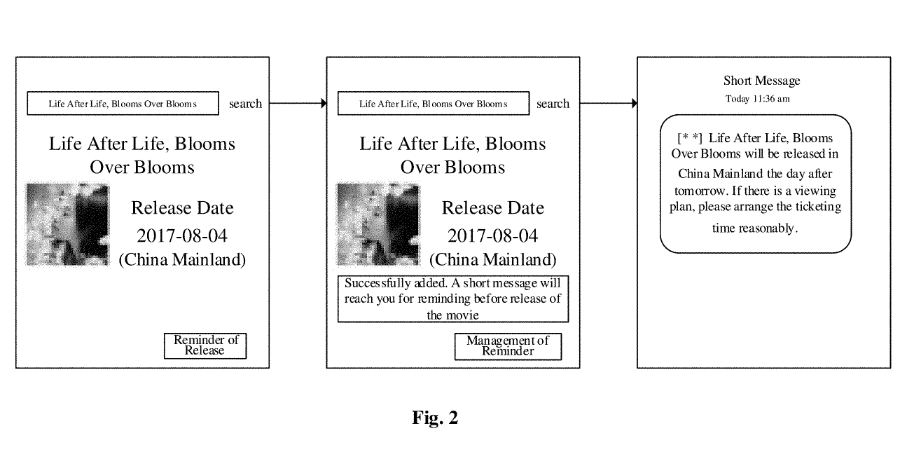

FIG. 2 shows pictures of an application scenario of this embodiment. A user inputs a search word in a search page, e.g., “Life After Life, Blooms Over Blooms”, and the release date of the movie is shown in the search page, e.g., Aug. 4, 2017. The user is very interested in the movie and sends a reminder request. The server, after confirming the reminder request, sends the user a prompt to notice success of the setting, i.e., “Successfully added. A short message will reach you for reminding before release of the movie”. Then, the server of the web search platform sends the user a short message to reminder the user 29 hours before the movie is released, as shown in the rightmost picture in FIG. 2.

Those skilled in the art can understand that no matter whether the user sends a reminder request to the web search platform or the web search platform sends reminder information to the user, actually, both of them relate to information interaction between the server of the web search platform and the user. For convenience of description, the server of the web search platform is sometimes directly presented as the web search platform, which actually refers to the server of the web search platform.

One of the above-described technical solutions has the following advantages or advantageous effects: a user, when using a web search platform, can directly send a reminder request for a preset event whose related information is displayed on the web search platform, and when a reminder triggering condition is met, the web search platform sends reminder information for the preset event to the user; the web search platform can provide more diversified services for the user and offer convenience for the user in a better way.

### Embodiment 2

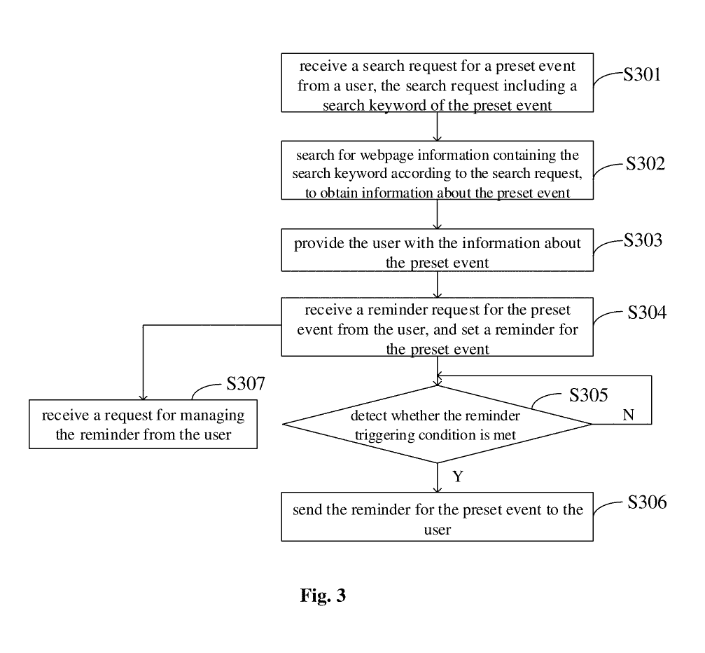

An event reminding method is provided according to Embodiment 2 of the present disclosure. As shown in FIG. 3, the event reminding method according to Embodiment 2 of the disclosure includes steps S301-S307.

S301, a search request for a preset event is received from a user, the search request including a search keyword of the preset event.

S302, webpage information containing the search keyword is searched for according to the search request, to obtain information about the preset event.

S303, the user is provided with the information about the preset event.

S304, a reminder request for the preset event is received from the user, the reminder request including a reminder triggering condition; and a reminder for the preset event is set.

This embodiment of the present disclosure is to solve the technical problem that when a user uses a search engine to retrieve information, he/she sees information about an event, shows interest in the event and then wants a reminder for the event. Therefore, when the user is using the web search platform, the web search platform conducts searches according to a search word input by the user and sends the searched webpage to the user. The webpage contains information about a preset event, and the user sets a reminder for the preset event.

S305, whether the reminder triggering condition is met is detected; if yes, step S306 is executed; otherwise, the detection continues.

S306, the reminder for the preset event is sent to the user.

S307, a request for managing the reminder is received from the user; wherein said managing includes at least one of the following operations: addition, deletion and modification.

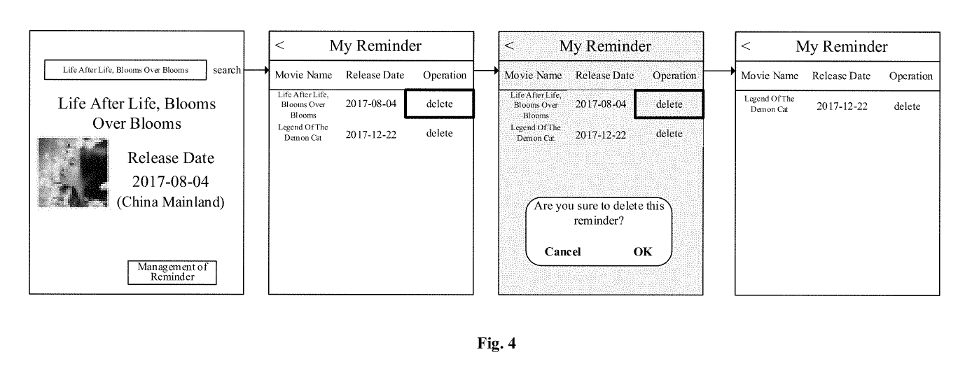

As shown in FIG. 4, specifically, the user, after sending the reminder request, can also manage (e.g., add, delete and modify) the reminder. For instance, after setting the reminder for the release date of the Chinese movie “Life After Life, Blooms Over Blooms”, the user can enter a management page if he/she intends to delete the reminder for the movie. As shown in the leftmost picture in FIG. 4, the user can click a button for managing the reminder after entering the management page, and then can click a deletion button corresponding to the movie item, and the web search platform will send a prompt to the user to ask the user for confirmation of the deletion of the reminder so as to avoid deletion by mistake. The reminder will be deleted upon receipt of the user's confirmation, as shown in the rightmost picture in FIG. 4.

Further, the reminder includes reminding content, reminding time and reminding manner.

Specifically, the reminding content refers to the matters that need to be reminded, for example, a release date of a movie and a commemoration day (such as a commemoration day of some activity). Further, for example, the Chinese movie “Life After Life, Blooms Over Blooms” will be released on *(month) *(day), *(year), and a user who is very interested in the movie sees the release date of the movie “Life After Life, Blooms Over Blooms” when searching through the web search platform. In order to avoid missing the release of the movie, the user can send a reminder request on the web search platform. Interface of the web search platform usually may provide a reminder button, and the user can send the reminder request to the server of the web search platform after clicking the reminder button. The server can send reminder information to the user a certain time before release of the movie, e.g., 24 hours before the release. For another example, if the commemorative activity is to be held on the Youth Day (May 4th), a user can directly set a reminder through the web search platform to facilitate preparation for the activity before the Youth Day.

As a variation of this embodiment, a reminder can also be set through the web search platform for a date which is special to a user, e.g., wedding anniversary or birthday of the user. For example, if the user's birthday is *(month) *(day), the user can search for this date through the web search platform, and he/she can click the reminder button and send a reminder request to the server when the date comes, so that the server sends a reminder to the user before this date.

The reminding time can be set upon user's requirements. For example, if a user who is abroad intends to celebrate an anniversary or birthday for his/her family in the mainland of China, he/she needs to be reminded a long time ahead of the anniversary or birthday so that the user can make schedules for the travel. For example, the reminder information is sent to the user three days ahead.

Further, the reminding manner includes at least one of: short message, email and phone call.

Specifically, when a user uses the web search platform, he/she may log in the web search platform firstly, that is, has entered user's personal information into the web search platform. The personal information may include user's phone number, email account or the like. Accordingly, without the need for the user to provide the information again, the web search platform will automatically send information or email to or call the user to reminder the user. Of course, the web search platform can also send information through chat software such as Wechat to reminder the user.

One of the above technical solutions has the following advantages or advantageous effects: this embodiment can set reminding time and reminding manner according to the user's actual need; for example, in the case where a user uses email every day instead of a terminal device, an email may be sent to the user for his/her convenience.

### Embodiment 3

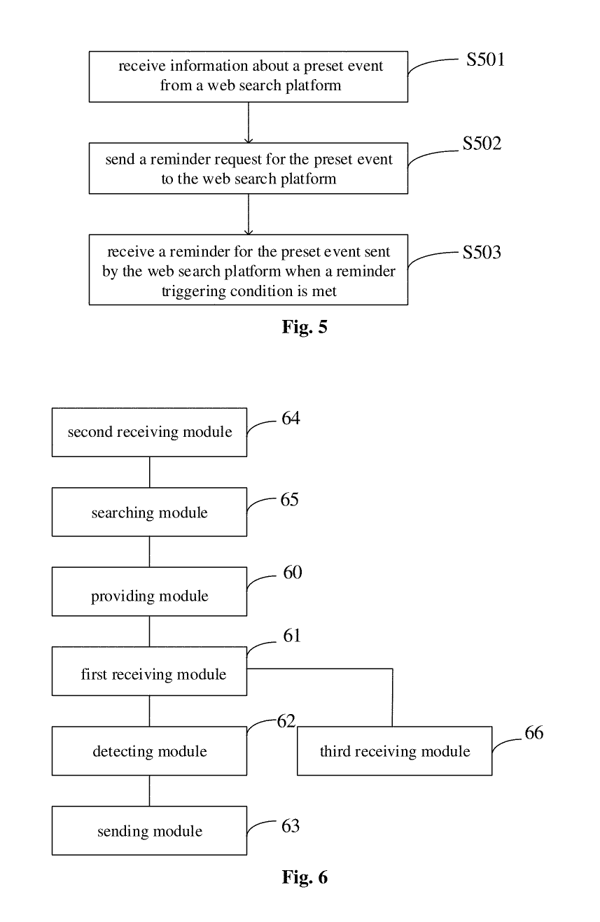

An event reminding method is provided according to Embodiment 3 of the present disclosure. As shown in FIG. 5, the event reminding method according to Embodiment 3 of the present disclosure includes:

S501, receiving information about a preset event from a web search platform;

S502, sending a reminder request for the preset event to the web search platform, the reminder request including a reminder triggering condition;

S503, receiving a reminder for the preset event from the web search platform when the reminder triggering condition is met.

The execution subject of the embodiment of the present disclosure is a client. That is to say, a user accesses a web search platform through the client, and then sends a reminder request to the server of the web search platform through the web search platform. The server detects whether the triggering condition is met, and the server of the web search platform sends reminder information to the user when the triggering condition is met, wherein the reminder request includes a reminder triggering condition. For example, when the time is taken as a reminder triggering condition, reminder information is sent to the user 29 hours ahead of occurrence of the preset event. As a further example, the user is very interested in the Chinese movie “Life After Life, Blooms Over Blooms”. When the user finds the movie by searching through the web search platform, he/she sends a reminder request to the server, e.g., requesting a reminder 29 hours ahead of release of the movie. Then, when the time comes, the server of the web search platform sends reminder information to the user. Herein, the time can be set as required. For example, the movie “Life After Life, Blooms Over Blooms” will be released on August 4, and if the reminder is set to be sent 24 hours in advance, the reminder information will be sent to the user at about 0 a.m. on August 3, which, however, may disturb the sleeping user. For this reason, the user can adjust the reminder triggering condition so that the reminder can be sent 29 hours in advance, that is, the reminder information may be sent at 7:00 p.m. on August 2.

One of the above-described technical solutions has the following advantages or advantageous effects: a user, when using a web search platform, can directly send a reminder request for a preset event whose related information is displayed on the web search platform, and when a reminder triggering condition is met, the web search platform sends reminder information for the preset event to the user; the web search platform can provide more diversified services for the user and offer convenience for the user in a better way.

### Embodiment 4

An event reminding device is provided according to Embodiment 4 of the present disclosure. As shown in FIG. 6, the event reminding device according to Embodiment 4 of the present disclosure includes a providing module 60, a first receiving module 61, a detection module 62 and a sending module 63.

The providing module 60 is configured for providing a user with information about a preset event for which the user requests a search.

The first receiving module 61 is configured for receiving a reminder request for the preset event from the user, the reminder request including a reminder triggering condition; and setting a reminder for the preset event.

The detection module 62 is configured for detecting whether the reminder triggering condition is met.

The sending module 63 is configured for sending a reminder for the preset event to the user when the reminder triggering condition is met.

One of the above-described technical solutions has the following advantages or advantageous effects: a user, when using a web search platform, can directly send a reminder request for a preset event whose related information is displayed on the web search platform, and when a reminder triggering condition is met, the web search platform sends reminder information for the preset event to the user; the web search platform can provide more diversified services for the user and offer convenience for the user in a better way.

Further, the event reminding device according to the embodiment 4 of the present disclosure also includes a second receiving module 64 and a searching module 65.

The second receiving module 64 is configured for receiving a search request for a preset event from a user, the search request including a search keyword of the preset event.

The searching module 65 is configured for searching for, according to the search request, webpage information containing the search keyword to obtain information about the preset event.

Further, the device also includes a third receiving module 66.

The third receiving module 66 is configured for receiving a request for managing the reminder from the user, wherein said managing includes at least one of the following operations: addition, deletion and modification.

The event reminding device according to the embodiment of the present disclosure is a product corresponding to the event reminding method as shown in FIGS. 1 to 5, and the advantageous effect of sending reminder information for the preset event to the user by the web search platform that can be achieved by the product is the same as the advantageous effect of the embodiments as illustrated in FIGS. 1 to 5, which will not be repeated herein.

### Embodiment 5

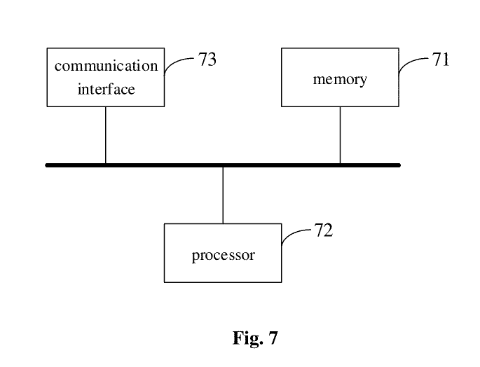

A server is provided according to Embodiment 5 of the present disclosure. As shown in FIG. 7, the server includes a memory 71 and a processor 72. A computer program that can run on the processor 72 is stored in the memory 71. When the processor 72 executes the computer program, the information reminder method in the above embodiment is implemented. The number of each of the memory 71 and the processor 72 may be one or more.

The device also includes:

a communication interface 73, configured to enable the memory 71 and the processor 72 to communicate with an external device.

The memory 71 may include a high-speed RAM memory, or may also include a non-volatile memory, such as at least one disk memory.

If the memory 71, the processor 72 and the communication interface 73 are implemented independently, the memory 71, the processor 72 and the communication interface 73 may be connected to each other via a bus so as to realize mutual communication. The bus may be an industry standard architecture (ISA) bus, a peripheral component interconnect (PCI) bus, an extended industry standard architecture (EISA) bus, or the like. The bus may be categorized into an address bus, a data bus, a control bus or the like. For ease of illustration, only one bold line is shown in FIG. 7 to represent the bus, but it does not mean that there is only one bus or only one type of bus.

Optionally, in a specific embodiment, if the memory 71, the processor 72 and the communication interface 73 are integrated on one chip, then the memory 71, the processor 72 and the communication interface 73 can complete mutual communication through an internal interface.

### Embodiment 6

A computer-readable storage medium stores a computer program which, when executed by a processor, implements the method as described in any of the embodiments of FIGS. 1 to 5.

In the present specification, the description referring to the terms “one embodiment”, “some embodiments”, “an example”, “a specific example”, or “some examples” or the like means that the specific features, structures, materials, or characteristics described in connection with the embodiment or example are contained in at least one embodiment or example of the disclosure. Moreover, the specific features, structures, materials, or characteristics described may be combined in a suitable manner in any one or more embodiments or examples. In addition, various embodiments or examples described in the specification as well as features of different embodiments or examples may be united and combined by those skilled in the art, as long as they do not contradict with each other.

Furthermore, terms “first” and “second” are used for descriptive purposes only, and are not to be construed as indicating or implying relative importance or implicitly indicating the number of recited technical features. Thus, a feature defined with “first” and “second” may include at least one said feature, either explicitly or implicitly. In the description of the present disclosure, the meaning of “a plurality” is two or more than two, unless otherwise explicitly or specifically indicated.

Any process or method described in the flowcharts or described otherwise herein may be construed as a module, segment or portion of code representing executable instructions including one or more steps for implementing a particular logical function or process. The scope of the preferred embodiments of the present disclosure includes other implementations in which functions may be implemented in an order that is not shown or discussed, including in a substantially concurrent manner or in a reverse order based on the functions involved. All these should be understood by those skilled in the art to which the embodiments of the present disclosure belong.

The logics and/or steps represented in the flowchart or otherwise described herein for example may be considered as an ordered list of executable instructions for implementing logical functions. They can be specifically embodied in any computer-readable medium for use by an instruction execution system, apparatus or device (e.g., a computer-based system, a system including a processor, or another system that can obtain instructions from the instruction execution system, apparatus or device and execute these instructions) or for use in conjunction with the instruction execution system, apparatus or device. As for the present specification, “computer-readable medium” can be any means that can contain, store, communicate, propagate or transmit programs for use by an instruction execution system, apparatus or device or for use in conjunction with the instruction execution system, apparatus or device.

The computer-readable medium described in the embodiments of the disclosure may a computer-readable signal medium or a computer-readable storage medium or any combination of a computer-readable signal medium and a computer-readable storage medium. More specific examples (non-exhaustive list) of a computer-readable storage medium at least include: an electrical connection (a electronic device) having one or more wires, a portable computer disk cartridge (a magnetic device), random access memory (RAM), a read only memory (ROM), an erasable programmable read-only memory (EPROM or flash memory), a fiber optic device, and a portable read only memory (CDROM). In addition, the computer-readable storage medium may even be a paper or another suitable medium on which the program can be printed. This is because for example the paper or another medium can be optically scanned, followed by editing, interpretation or, if necessary, other suitable ways of processing so as to obtain the program electronically, which are then stored in a computer memory.

In an embodiment of the disclosure, the computer-readable signal medium may include a data signal propagating in a baseband or as a part of a carrier, in which a computer-readable program code is carried. Such propagating data signal can take a variety of forms including, but not limited to, electromagnetic signal, optical signal, or any suitable combination of the electromagnetic signal and optical signal. The computer-readable signal medium may also be any computer-readable medium other than a computer-readable storage medium, and the computer-readable medium can send, propagate or transmit a program for use by an instruction execution system, an input method, or a device or for use in conjunction with an instruction execution system, an input method, or a device. The program code embodied in the computer-readable medium can be transmitted by any suitable medium, including but not limited to: wireless, wire, optic cable, radio frequency (RF), etc., or any suitable combination of the foregoing.

It should be understood that individual portions of the present disclosure may be implemented in the form of hardware, software, firmware, or a combination thereof. In the above embodiments, a plurality of steps or methods may be implemented using software or firmware stored in a memory and executed by a suitable instruction execution system. For example, if they are implemented in hardware, as in another embodiment, they are implemented using any one or a combination of the following techniques known in the art: discrete logic circuit having logic gate circuit for implementing logic function on data signal, application-specific integrated circuit having suitable combined logic gate circuit, programmable gate array (PGA), field programmable gate array (FPGA), etc.

Those skilled in the art may understand that all or some of the steps carried in the method of the foregoing embodiments may be implemented by using a program to instruct the relevant hardware, and the program may be stored in a computer-readable storage medium. When executed, the program includes one or a combination of the steps in the method embodiments.

In addition, individual functional units in various embodiments of the present disclosure may be integrated in one processing module, or individual units may also exist physically and independently, or two or more units may also be integrated in one module. The above integrated module can be implemented in the form of hardware or in the form of a software functional module. The integrated module may also be stored in a computer-readable storage medium if it is implemented in the form of a software functional module and sold or used as a stand-alone product. The storage medium may be a read-only memory, a magnetic disk or an optical disk, etc.

The above description only relates to specific embodiments of the present disclosure, but the scope of protection of the present disclosure is not limited thereto, and any of those skilled in the art can readily contemplate various changes or replacements within the technical scope of the present disclosure. All these changes or replacements should be covered by the scope of protection of the present disclosure. Therefore, the scope of protection of the present disclosure should be determined by the scope of the appended claims.

What is claimed is:

1. An event reminding method, the method comprising:
providing a user with information about a preset event for which the user requests a search;
receiving a reminder request for the preset event from the user, the reminder request comprising a reminder triggering condition; and setting a reminder for the preset event;
detecting whether the reminder triggering condition is met; and
sending the reminder for the preset event to the user when the reminder triggering condition is met.

2. The method of claim 1, wherein before providing the user with information about the preset event for which the user requests the search, the method further comprises:
receiving a search request for the preset event from the user, the search request including a search keyword of the preset event; and
searching for webpage information containing the search keyword according to the search request, to obtain information about the preset event.

3. The method of claim 1, further comprising: receiving a request for managing the reminder from the user, wherein said managing comprises at least one of the following operations: addition, deletion and modification.

4. The method of claim 1, wherein the reminder comprises reminding content, reminding time and reminding manner.

5. The method of claim 4, wherein the reminding manner comprises at least one of: short message, email, and phone call.

6. An event reminding method, the method comprising:
receiving information about a preset event from a web search platform;
sending a reminder request for the preset event to the web search platform, the reminder request comprising a reminder triggering condition; and
receiving a reminder for the preset event sent by the web search platform when the reminder triggering condition is met.

7. An event reminding device, the device comprising:
a providing module configured for providing a user with information about a preset event for which the user requests a search;
a first receiving module configured for receiving a reminder request for the preset event from the user, the reminder request comprising a reminder triggering condition; and for setting a reminder for the preset event;
a detecting module configured for detecting whether the reminder triggering condition is met; and
a sending module configured for sending a reminder for the preset event to the user when the reminder triggering condition is met.

8. The device of claim 7, further comprising:
a second receiving module configured for receiving a search request for the preset event from the user, the search request including a search keyword of the preset event; and
a searching module configured for searching for webpage information containing the search keyword according to the search request, to obtain the information about the preset event.

9. The device of claim 7, further comprising:
a third receiving module configured for receiving a request for managing the reminder from the user; wherein said managing comprises at least one of the following operations: addition, deletion and modification.

10. A server, the server comprising:
one or more processors;
a storage device configured for storing one or more programs; and
a communication interface configured for enabling the processor and the storage device to communicate with an external device;
wherein the one or more programs are executed by the one or more processors, to enable the one or more processors to implement the method of claim 1.

11. A computer-readable storage medium, in which a computer program is stored, wherein the computer program implements the method of claim 1 when executed by a processor.
